(19) United States
(12) Patent Application Publication
(10) Pub. No.: US 2006/0280111 A1
(43) Pub. Date: Dec. 14, 2006

(54) Optical storage medium and optical recording method

(75) Inventors: Ikuo Matsumoto, Ibaraki-Ken (JP); Kenji Tokui, Ibaraki-Ken (JP); Hiroshi Tabata, Ibaraki-Ken (JP)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(73) Assignee: Victor Company of Japan, Ltd.

(21) Appl. No.: 11/451,003

(22) Filed: Jun. 12, 2006

(30) Foreign Application Priority Data
Jun. 14, 2005 (JP) 2005-173642
Apr. 18, 2006 (JP) 2006-114461

(51) Int. Cl. G11B 3/70; G11B 7/00

(52) U.S. Cl. 369/288; 369/44.39

(57) ABSTRACT

Data is recorded in an optical storage medium with a beam having a wavelength in a 650-nm band. The medium has a substrate, a first laminated layer structure formed on the substrate and having at least a first reflective film and a first recording film, and a second laminated layer structure formed over the first structure and having at least a second reflective film and a second recording film. The data is recorded in at least one of specific sections of the first recording film, with a beam having a wavelength in a 650-nm band and a beam spot having a specific area. The first structure satisfies requirements Tc≦Tr≦60% and 9%≦Rr≦Rc≦15% wherein Tc and Rc are a transmissivity and a reflectivity, respectively, of the first structure when the first recording film has no data recorded therein after initialized, and Tr and Rr are a transmissivity and a reflectivity, respectively, of the first structure when the first recording film has the data recorded therein. The transmissivity Tc and the reflectivity Rc, and the transmissivity Tr and the reflectivity Rr are exhibited by the first structure when the beam is emitted thereto through the substrate as a parallel beam having a sectional area in a direction orthogonal to another direction in which the beam travels. The sectional area is larger than the specific area. Data is recorded in the second recording film through the substrate and the data-recorded specific section of the first recording film. The second structure exhibits a reflectivity of 5% or higher but 10% or lower when the beam is focused onto the second recording film, as having the beam spot having the specific area, through the substrate and the first structure, and when the first recording film has the data recorded therein.

### CROSS-REFERENCE TO RELATED APPLICATIONS

This application is based on and claims the benefit of priority from the prior Japanese Patent Application No. 2005-173642 filed on Jun. 14, 2005 and Japanese Patent Application No. 2006-114461 filed on Apr. 18, 2006, the entire contents of which are incorporated herein by reference.

### BACKGROUND OF THE INVENTION

The present invention relates to an optical storage medium, in or from which data is recorded, erased or reproduced with irradiation of a light beam (for example, a laser beam) and an optical recording method for recording data to such an optical storage medium.

Phase-change optical storage media are data-rewritable storage media using a phenomenon of reversible change between the crystalline phase and the amorphous phase. Representative of such media are recent CD-RW (rewritable compact disc), DVD-RW (rewritable digital versatile disc) and DVD-RAM (rewritable random access digital versatile disc). Especially, DVD-RW and DVD-RAM are used for recording and rewriting a large amount of data, such as video data.

Phase-change optical storage media becoming rapidly popular for use in video recorders, personal computers, etc., have to meet more demand for higher storage capacity and higher density recording, in addition to excellent recording and overwrite characteristics.

One known technique to increase storage capacity of phase-change optical storage media is to produce a smaller laser spot carrying a signal to be recorded to achieve higher storage density per unit area. A smaller laser spot can be obtained with a shorter laser wavelength or a higher numerical aperture (NA) for an objective lens. One exemplary medium using such a technique is Blu-Ray disc.

The Blu-Ray disc has storage capacity of 23 gigabytes per layer, compared to 4.7 gigabytes per layer for DVD. Such high storage capacity is achieved with a laser beam of 405 nm in wavelength and an objective lens of 0.85 in NA, compared to 650 nm in wavelength and 0.60 in NA for DVD.

Another known technique to increase storage capacity of phase-change optical storage media is to form several recording layers as being overlapped each other with other layers intervening therebetween, thus producing a multilayer optical storage medium. Already popular on the market is DVD-ROM (Read Only Memory) with two recording layers.

Such multilayer optical storage media enjoy storage capacity of a two-fold increase with two recording layers, a four-fold increase with four recording layers, and so on. Already on the market is a write-once dual-layer optical storage medium with two overlapped organic-dye recording layers, such as, DVD+R dual-layer (DL) disc. Such a dual-layer optical storage medium with increased storage capacity enjoys recording through a low-cost system with a laser wavelength and an objective lens NA customarily used.

DVD-ROM, or a read only medium, has a multilayer structure of reflective films laminated on a disc substrate. In contrast, a phase-change optical storage medium has a multilayer structure of recording films (layers) laminated on a disc substrate.

Discussed below is a structure of a phase-change optical storage medium having a single rewritable recording film and a recording method therefor.

A single-layer phase-change optical storage medium has a structure in which at least a dielectric film, a recording film, another dielectric film and a reflective film are laminated in order on a substrate having a bottom surface to be irradiated with a laser beam carying a recording or reproducing power, or an erasing power. In a phase-change optical storage medium having such a structure, recording pulses are applied (irradiated) onto a recording film with a laser beam having a recording power, to melt and then rapidly cool down the recording film, thus forming amorphous recorded marks thereon. Reflectivity of the recorded marks lower than that of a crystalline-state recording film allows optical reading of the marks as recorded data. In erasing the recorded marks, a laser beam having a power (erasing power) smaller than the recording power is irradiated onto the recording film to raise the temperature thereof to a temperature in the range from the crystallization temperature to the melting point to change the recording film from the amorphous phase to the crystalline phase, thus overwriting being enabled. One-beam overwriting with such recording and erasing through single laser radiation is preferable for a shortened rewriting period.

A phase-change optical storage medium having two rewritable recording films has two laminated layer structures formed on a substrate. Each laminated layer structure has at least a dielectric film, a recording film, another dielectric film and a reflective film laminated in order, like the single-layer phase-change optical storage medium, discussed above.

Japanese Unexamined Patent Publication No. 2003-338079 (referred to as document 1, hereinafter) discusses a particular problem on a multilayer optical storage medium having several data layers. Two of the data layers are a data layer L0 located closest to the laser-incident side of the storage medium and a data layer L1 located farthest from the laser-incident side.

Such a data (or recording) layer L0 and a data (or recording) layer L1 located closest to and farthest from, respectively, the laser-incident side of an optical storage medium are referred to in the following discussion.

The problem discussed in the document 1 is that change between the crystalline and the amorphous phase in a recording film of the data layer L0, depending on whether the layer L0 has been recorded or not, affects recording and reproduction to and from the data layer L1.

The document 1 discloses a recording film, for the data layer L0, having a smaller difference in transmissivity or absorption rate between the crystalline and the amorphous phase, for accurate recording and reproduction to and from the data layer L1, irrespective of whether the recording film of the data layer L0 is in the crystalline phase (unrecorded) or the amorphous phase (recorded). The crystalline and amorphous phases are optically detectable.

The inventors of the present invention confirmed the advantages discussed in the document 1 in use of of chalcogen compound materials, such as, TeGeSb and InSe (introduced in the document 1) for the recording films, discussed above.

However, the inventors of the present invention also confirmed difficulty in achieving a smaller difference in transmissivity between the crystalline and amorphous phases in use of first crystal growth materials (FGM), such as, AgInSbTe, InGeSb and GaSb, exhibiting a high crystallization speed for the recording film, discussed above. Moreover, FGM recording films require rapid cooling characteristics that restricts thickness of films in the optical storage medium, thus having difficulty in achieving excellent recording and overwrite characteristics.

Japanese Unexamined Patent Publication No. 2003-303420 (referred to as document 2, hereinafter) discusses a recording method for a multilayer optical storage medium. In the recording method, recording starts from the recording layer located farthest from the laser-incident side of the storage medium and proceeds toward recording layers located closer to the laser-incident side, or vice versa. No reference is made for difference in transmissivity in the recording film, like discussed in the document 1.

The inventors of the present invention confirmed difference in transmissivity and absorption rate between before and after performing the recording method disclosed in the document 2, depending on materials and/or thickness of the recording film (medium production requirements). A specific order of recording procedure for the several recording layers caused poor recording characteristics, depending on the medium production requirements.

It is also a problem to loose compatibility among optical storage media due to change in order of recording procedure per medium. It is thus important to establish a recording method based on the characteristics of optical storage media.

There are two types of recording order in a dual-layer phase-change optical storage medium according to the recording method disclosed in the document 2: recording staring from a recording layer L1 that requires a laser beam to pass through a crystalline-state (unrecorded) recording film in a recording layer L0; and recording starting from the recording layer L0 that requires a laser beam to pass through an amorphous-state (recorded) recording film in this layer L0, for recording in the recording layer L1.

Difference in transmissivity between the recorded and unrecorded states of the recording film in the recording layer L0 becoming larger depending on the recording order causes poor recording characteristics due to change in laser power or decrease in reproduced signal level. Therefore, the recording method discussed in the document 2 requires such a recording film, disclosed in the document 1, having a smaller difference in transmissivity or absorption rate between the crystalline and the amorphous phase.

### SUMMARY OF THE INVENTION

A purpose of the present invention is to provide a phase-change optical storage medium having two recording films each exhibiting excellent recording and overwrite characteristics and an optical recording method for such a phase-change optical storage medium.

The present invention provides a n optical storage medium comprising: a substrate; a first laminated layer structure formed on the substrate and having at least a first reflective film and a first recording film; and a second laminated layer structure formed over the first laminated layer structure and having at least a second reflective film and a second recording, the second laminated layer structure exhibiting a reflectivity of 5% or higher but 10% or lower when a beam having a wavelength in a 650-nm band is focused onto the second recording film, as having a beam spot having a specific area, through the substrate and the first laminated layer structure, and when the first recording film has data recorded therein.

Moreover, the present invention provides a method of recording data in an optical storage medium comprising the steps of: recording data in the optical storage medium having a substrate, a first laminated layer structure formed on the substrate and having at least a first reflective film and a first recording film, and a second laminated layer structure formed over the first laminated layer structure and having at least a second reflective film and a second recording film, the data being recorded in at least one of a plurality of specific sections of the first recording film of the first laminated layer structure, with a beam having a wavelength in a 650-nm band and a beam spot having a specific area, the first laminated layer structure satisfying requirements Tc≦Tr≦60% and 9%≦Rr≦Rc≦15% wherein Tc and Rc are a transmissivity and a reflectivity, respectively, of the first laminated layer structure when the first recording film has no data recorded therein after initialized, and Tr and Rr are a transmissivity and a reflectivity, respectively, of the first laminated layer structure when the first recording film has the data recorded therein, the transmissivity Tc and the reflectivity Rc, and the transmissivity Tr and the reflectivity Rr being exhibited by the first laminated layer structure when the beam is emitted thereto through the substrate as a parallel beam having a sectional area in a direction orthogonal to another direction in which the beam travels, the sectional area being larger than the specific area; and recording data in the second recording film of the second laminated layer structure through the substrate and the data-recorded specific section of the first recording film of the first laminated layer structure, the second laminated layer structure exhibiting a reflectivity of 5% or higher but 10% or lower when the beam is focused onto the second recording film, as having the beam spot having the specific area, through the substrate and the first laminated layer structure, and when the first recording film has the data recorded therein.

### BRIEF DESCRIPTION OF DRAWINGS

FIG. 1 is an enlarged cross section illustrating an embodiment of an optical storage medium according to the present invention;

FIG. 2 is a graph indicating transmissivity versus recording-film thickness, with reflective-film thickness as parameter;

FIG. 3 is a graph indicating jitter versus overwrite times, with recording-film as parameter;

FIG. 4 is a graph indicating 3T-signal CNR versus reflectivity;

FIG. 5 is a graph indicating reflectivity versus transmissivity between two laminated layer structures;

FIG. 6 is a view illustrating an example of a recording pulse sequence;

FIG. 7 is a block diagram of an embodiment of an optical recording/reproduction apparatus according to the present invention;

FIG. 8 is a plan view illustrating the optical storage medium according to the present invention;

FIG. 9 is an illustration of three recording file systems for the optical storage medium according to the present invention;

FIG. 10 is a table listing measured data for several samples of the optical storage medium according to the present invention; and

FIG. 11 is a table listing measured data for several samples of the optical storage medium according to the present invention.

### DETAILED DESCRIPTION OF PREFERRED EMBODIMENTS

Representative of dual-layer phase-change optical storage media having two laminated layer structures (which will be defined later) each having a recording film are phase-change optical discs such as DVD-RW and DVD-RAM, and optical cards, media capable of repeatedly overwriting data.

A dual-layer phase-change optical disc (an optical storage medium A) is described in the following description as an embodiment of an optical storage medium according to the present invention. It will, however, be appreciated that the present invention is applicable to other types of phase-change optical storage media such as optical cards.

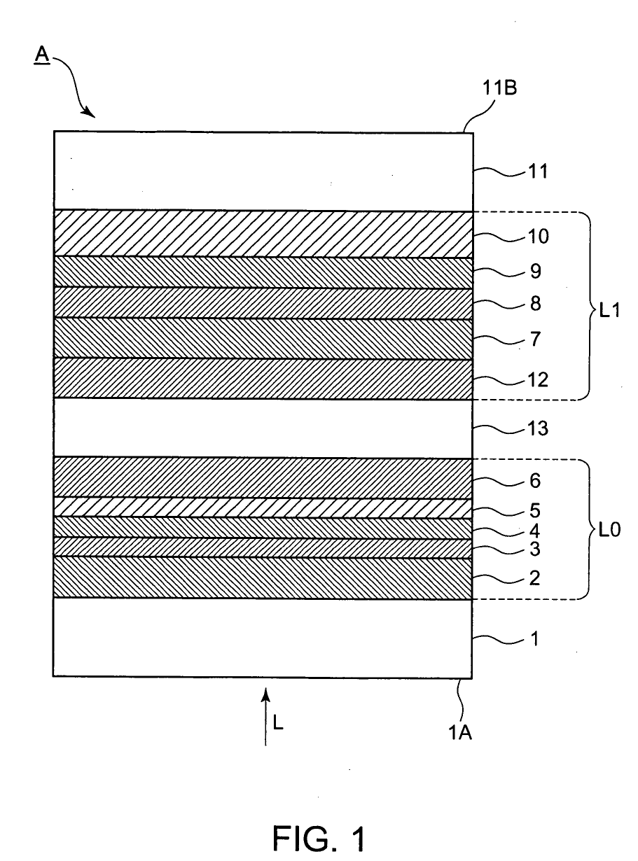

FIG. 1 is a longitudinal sectional view illustrating a laminated structure of a dual-layer optical storage medium A, a preferred embodiment according to the present invention.

The dual-layer optical storage medium A has a first laminated layer structure L0 and a second laminated layer structure L1. The first laminated layer structure L0 is formed on a first substrate 1 having a bottom surface that is a light-incident surface 1A via which a laser beam is incident in recording, reproduction or erasure. The second laminated layer structure L1 is formed on a second substrate 11. The first and second laminated layer structures L0 and L1 are laminated via an intermediate (transparent) layer 13.

The first laminated layer structure L0 is located closer to the laser-incident side (light-incident surface 1A) of the optical storage medium A. The second laminated layer structure L1 is located farther from the laser-incident side of the optical storage medium A.

The first laminated layer structure L0 consists of a first dielectric film 2, a first recording film 3, a second dielectric film 4, a first reflective film 5, and a first protective film 6, laminated in order on the first substrate 1.

The second laminated layer structure L1 consists of a second reflective film 10, a third dielectric film 9, a second recording film 8, a fourth dielectric film 7, and a second protective film 12, laminated in order on the second substrate 11 having a labeling surface 11B.

The first and second laminated layer structures L0 and L1 are bonded to each other via the intermediate (transparent) layer 13 so that the first protective film 6 (in the structure L0) and the second protective film 12 (in the structure L1) face each other. The transparent layer 13 may be a ultraviolet (UV) curable resin or a double-sided adhesive sheet, and sometimes referred to as a boding layer in the following disclosure.

Suitable materials for the first and second substrates 1 and 11 are several types of transparent synthetic resins, a transparent glass, and so on. It is preferable to use a transparent first substrate 1 for protection against dust and damages so that recording can be performed at the first substrate side with a focused laser beam through the light-incident surface 1A of this substrate. Suitable materials for the substrates 1 and 11 in such use are, for example, glass, polycarbonate, polymethylmethacrylate, polyolefin resin, epoxy resin, and polyimide resin. Most suitable material is polycarbonate resin for low birefringence and hygroscopicity, and also easiness to process.

Although not limited, in compatibility with DVD, the thickness of the first and second substrates 1 and 11 is preferably in the range from 0.58 mm to 0.6 mm (for the total DVD thickness of 1.2 mm). The substrates 1 and 11 may be flexible or rigid. Flexible substrates 1 and 11 may be used for tape-, sheet- or card-type optical storage media whereas rigid substrates 1 and 11 for card- or disk-type optical storage media.

The first and second dielectric films 2 and 4 protect the first substrate 1 and the first recording film 3 against heat which may otherwise cause poor recording characteristics, with an improved C/N (Carrier to Noise Ratio) for reproduced signals due to optical interference. The same is true for the third and fourth dielectric films 9 and 7 to the second substrate 11 and the second recording film 8.

The first, second, third and fourth dielectric films 2, 4, 9 and 7 (sometimes referred to as the first to fourth dielectric films in the following disclosure) allow a laser beam to pass therethrough in recording and reproduction, with a refractive index “n” in the range of 1.9≦n≦2.3. A suitable material for the first to fourth dielectric films is a material that exhibits high thermal characteristics, for example, an oxide such as SiO₂, SiO, ZnO, TiO₂, Ta₂O₅, Nb₂O₅, ZrO₂ and MgO, a sulfide such as ZnS, In₂S₃ and TaS₄, and carbide such as SiC, TaC, WC and TiC, or a mixture of these materials. The first to fourth dielectric films may or may not be made of the same material or composition. A mixture of ZnS and SiO₂ is the best for high recording sensitivity, C/N and erasing rate against repeated recording, reproduction or erasure.

The thickness of the first and third dielectric films 2 and 9 is in the range from about 5 nm to 500 nm, preferably, 40 nm to 300 nm so that they cannot be easily peeled off from the first substrate and recording film 1 and 3, and second substrate and recording film 11 and 8, respectively, and are not prone to damage such as cracks. The thickness below 40 nm hardly offers high disc optical characteristics whereas over 300 nm causes lower productivity. A more acceptable range is from 50 nm to 80 nm.

The thickness of the second and fourth dielectric films 4 and 7 is, preferably, in the range from 5 nm to 40 nm for high recording characteristics such as C/N and erasing rate, and also high stability in a number of repeated overwriting. The thickness below 5 nm hardly gives enough heat to the recording film, resulting in increase in optimum recording power, whereas over 40 nm causes poor overwrite characteristics. A more acceptable range is from 10 nm to 20 nm.

The first and second recording films 3 and 8 are a film of an alloy such as Ag—In—Sb—Te and Ge—In—Sb—Te, or of Ge—In—Sb—Te added with at least any one of Ag, Si, Al, Ti, Bi and Ga. A preferable thickness for the recording film 3 is 10 nm or less for easier transmission of light to the second laminated layer structure L1. A preferable thickness range for the recording film 8 is from 10 nm to 25 nm.

An interface film may be provided on either or each interface between the first recording film 3 and the first and second dielectric films 2 and 4. Another interface film may be provided on either or each interface between the second recording film 8 and the third and fourth dielectric films 9 and 7. One requirement for the interface film is that it is made of a material without including a sulfide. An interface film made of a material including a sulfide suffers diffusion of the sulfide into the first recording film 3 and/or the second recording film 8 when subjected to repeated overwriting, which could lead to poor recording characteristics, and also poor erasing characteristics.

An acceptable material for the interface film includes at least any one of a nitride, an oxide and a carbide, specifically, germanium nitride, silicon nitride, aluminum nitride, aluminum oxide, zirconium oxide, chromium oxide, silicon carbide and carbon. Oxygen, nitrogen or hydrogen may be added to the material of the interface layer. The nitride, oxide and carbide listed above may not be stoichiometric compositions for such an interface film. In other words, nitrogen, oxygen or carbon may be excessive or insufficient, which could offer high performance, such as high durability to the first laminated layer structure L0 and/or the second laminated layer structure L1 in that the interface film is hardly peeled off.

Preferable materials for the first reflective film 5 (semi-transparent in this embodiment) and the second reflective film 10 are a metal (that exhibits reflectivity), such as Al, Au and Ag, an alloy of any of these metals, as a major component, with at least one type of metal or semiconductor, and a mixture of a metal, such as Al, Au and Ag, and a metal nitride, a metal oxide or a metal chalcogen of Al, Si, etc. The term “major component” here means that a metal, such as Al, Au and Ag exceeds 50% or, preferably, 90% in all of the components of the first reflective film 5 and/or the second reflective film 10.

Most preferable among them is a metal, such as Al, Au and Ag, and also an alloy of any of these metals as a major component, for high reflectivity and thermal conductivity. A typical alloy is made of Al and at least one of the following elements: Si, Mg, Cu, Pd, Ti, Cr, Hf, Ta, Nb, Mn, Zr, etc., or Au or Ag and at least one of the following elements: Cr, Ag, Cu, Pd, Pt, Ni, Nd, In, Ca, etc. For high linear velocity recording, the most preferable one is a metal or an alloy having Ag exhibiting extremely high thermal conductivity, as a major component, in view of recording characteristics.

The thickness of the semi-transparent first reflective film 5 is preferably 10 nm or less for easier transmission of light to the second laminated layer structure L1. A preferable thickness range for the second reflective film 10 is from 50 nm to 300 nm, which depends on the thermal conductivity of a material used for this film. The reflective film 10 of 50 nm or more in thickness is optically stable in, particularly, reflectivity. Nevertheless, a thicker reflective film affects a cooling rate. Thickness over 300 nm requires a longer production time. A material exhibiting a high thermal conductivity allows the reflective film 10 to have a thickness in an optimum range such as mentioned above.

The first reflective film 5 and/or the second reflective film 10 may be of a multilayer structure in which a metal reflective film is sandwiched between highly conductive dielectric films.

[Measurements of Transmissivity]

The optical storage medium A in this embodiment requires that the first laminated layer structure L0 allow a laser beam to pass therethrough in recording or reproduction to or from the second laminated layer structure L1. To meet such a requirement, a dual-layer optical storage medium must exhibit at least 40% in transmissivity T0 for a laser beam at the layer structure L0 located closer to the light-incident surface 1A, according to simulation. In contrast, the layer structure L1 does not need to allow a laser beam passing therethrough because it is located farther from the light-incident surface 1A, and there is no laminated layer structure located farther than the structure L1 from the surface 1A. Thus, the recoding film, reflective film, etc., that constitute the layer structure L1 can have an enough thickness for required characteristics.

One factor defined in this disclosure is a reflectivity R11 of the second laminated layer structure L1. The reflectivity R11 is peculiar to the structure L1, exhibited when a laser beam hits this structure. Here, the structure L1 is formed on the second substrate 11 and bonded to the first substrate 1 (or a dummy substrate) with the bonding layer 13. The second protective film 12 faces with the substrate 1 via the layer 13, without the first laminated layer structure L0. The reflectivity R11 is referred to as an L1-peculiar reflectivity R11 in the following discussion.

The L1-peculiar reflectivity R11 is measured by an optical-disc drive tester (DDU1000, referred to as an evaluation instrument, hereinafter) made by Pulstec. Co. It is measured when a laser beam is focused onto the second recording film 8 (through the entire surface of the second laminated layer structure L1), with a laser spot having a specific area (referred as a first area, hereinafter). Each film in the structure L1 is very thin so that a laser beam incident through the entire surface of the structure L1 has an almost equal spot area to that (the first area) of the laser spot focused onto the recording film 8. The same is true for the first laminated layer structure L0 when a laser beam is incident through the entire surface of the structure L0.

Evaluation of reflectivity with the evaluation instrument is conducted as follows, according to the DVD-RW specifications: A signal modulated with 8/16 modulation is recorded in the optical storage medium A with a laser beam having a wavelength in compliance with the DVD-RW specifications in the optimum conditions. The recorded signal is reproduced with an appropriate reproduction power (1.4 mW in this embodiment). The maximum level (I14H-voltage level) of the reproduced signal is measured on an oscilloscope. Reflectivity is then evaluated with the measured voltage level in relation to a reference disc for which a specific voltage level has been known for a standard reflectivity.

A laser beam used in this embodiment has a wavelength of 650-nm band (650 nm±10 nm) in compliance with the DVD-RW specifications. The evaluation instrument used in this embodiment is equipped with 0.65-NA optical lens and a 658 nm-wavelength laser diode. The almost equal reflectivity is measured with any wavelength in the 650-nm band described above.

Another factor defined in this disclosure is a reflectivity R1 exhibited by the second laminated layer structure L1 when a laser beam, incident through the light-incident surface 1A, hits the structure L1 after passing through the first laminated layer structure L0. Here, the laser beam passes through the structure L0, reflected at the structure L1 and again passes through the structure L0. The reflectivity R1 is given by multiplying the transmissivity T0 of the structure L0 and the L1-peculiar reflectivity R11, or R1=T0×R11×T0. A laser beam used here has a wavelength in the 650-nm band described above. The reflectivity R1 is referred to as an L1-via-L0 reflectivity R1 in the following disclosure.

The transmissivity T0 of the first laminated layer structure L0 is defined in this disclosure as a transmissivity of light that is incident through the light-incident surface 1A of the first substrate 1 and passes through the structure L0 formed on the substrate 1. The transmissivity T0 of the structure L0 is measured with an analysis instrument ETA—RT made by Steag ETA—Optick GmBH., using a laser beam having a larger spot area (second area) than the first area (defined above in measurements of the L1-peculiar reflectivity R11). The second area is defined, in this disclosure, as a sectional area of a laser beam on the structure L0 in a direction orthogonal to a travel direction of the beam. In other words, a laser beam having the second area is emitted onto the structure L0 almost in parallel. Or, a laser beam emitted onto the structure L0 as having the second area is defined as a parallel beam in this disclosure.

The following discussion is made with a presupposition that the transmissivity T0 of the first laminated layer structure L0, the L1-via-L0 reflectivity R1 of the second laminated layer structure L1, and also the L1-peculiar reflectivity R11 of the structure L1 are not affected by a transmissivity of the first substrate 1, etc.

For example, when an L1-peculiar reflectivity R11 is set at 20% (the level of reflectivity for typical phase-change optical storage media), a transmissivity T0 of 40%, discussed above, gives an L1-via-L0 reflectivity R1 of 3.2% (=40%×20%×40%). Likewise, T0 of 45% and 50% give R1 of 4% and 5%, respectively, with the L1-peculiar reflectivity R11 of 20%.

To gain an L1-via-L0 reflectivity R1 of 10%, a transmissivity T0 of 72% is required when an L1-peculiar reflectivity R11 is 20%. Rise in L1-peculiar reflectivity R11 to 25% still requires a transmissivity T0 of 66% to gain 10% in L1-via-L0 reflectivity R1.

Accordingly, the L1-via-L0 reflectivity R1 of the second laminated layer structure L1 varies depending on the transmissivity T0 of the first laminated layer structure L0 and the L1-peculiar reflectivity R11 of the structure L1. In addition, a higher transmissivity T0 gives a higher L1-via-L0 reflectivity R1.

Therefore, the first laminated layer structure L0 requires a specific thickness to exhibit an appropriate transmissivity T0 and also offer an appropriate cooling rate to the first recording film 3 in recording. A thinner first recording film 3 and/or a thinner first reflective film 5, both basically exhibiting a high laser-beam absorption rate give a higher transmissivity T0.

In contrast, the second laminated layer structure L1 can have an enough or optimum thickness to enjoy the second recording film 8 and the second reflective film 10 for excellent recording characteristics. This is because the structure L1 located farther from the light-incident surface 1A does not need to allow a laser beam passing therethrough.

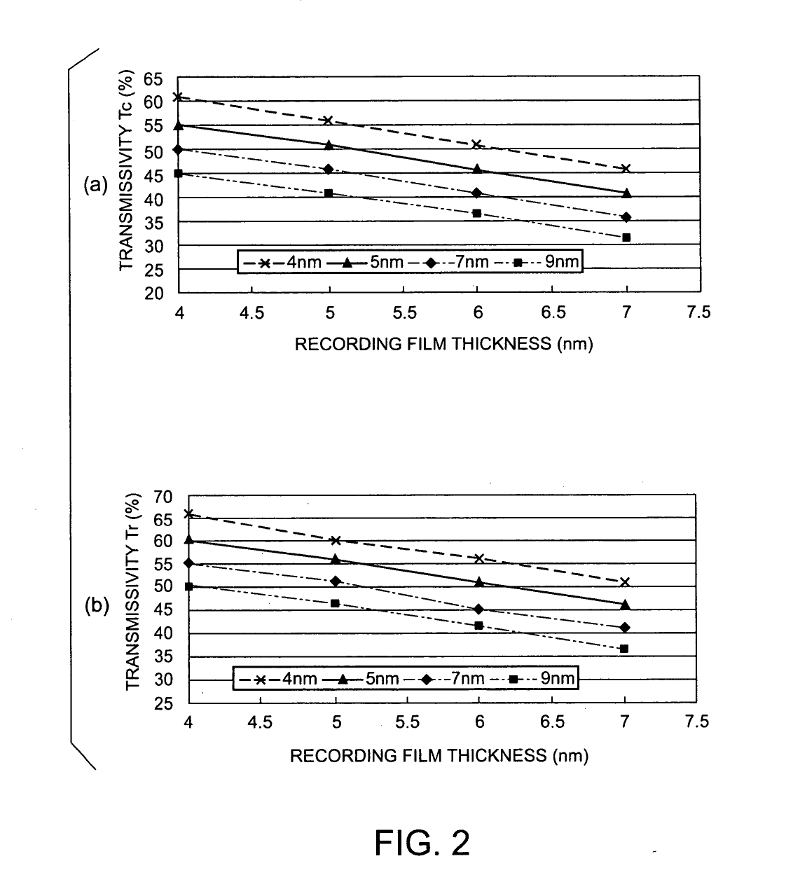

Shown in a graph (a) in FIG. 2 is a transmissivity Tc of the first laminated layer structure L0, when the first recording film 3 is in an unrecorded state (crystalline phase), versus a thickness of the film 3, with a thickness of the first reflective film 5 as a parameter.

Shown in a graph (b) in FIG. 2 is a transmissivity Tr of the first laminated layer structure L0, when the first recording film 3 is in a recorded state (crystalline and amorphous phases), versus a thickness of the film 3, with a thickness of the first reflective film 5 as a parameter. Recording was conducted only once for the recording film 3 with a recording power and a write strategy for offering excellent jitter characteristics at each combination of varied thicknesses of the recording film 3 and reflective film 5.

Both of the transmissivity Tc (unrecorded state) and Tr (recorded state) are sometimes referred to as the transmissivity T0 of the first laminated layer structure L0 in the following discussion.

As shown in the graph (a) in FIG. 2, the first laminated layer structure L0 exhibits a transmissivity Tc of 60% or higher when the thickness is 4 nm for both of the first recording film 3 and the first reflective film 5 (a combination of the minimum thicknesses for the films 3 and 5).

In contrast, when the first recording film 3 is in a recorded state, as shown in the graphs (b) in FIG. 2, the first laminated layer structure L0 exhibits a transmissivity Tr of 60% or higher when the thickness is 4 nm or 5 nm for both of the first recording film 3 and the first reflective film 5. This teaches that a 4-nm thick reflective film 5 accepts the same 4-nm thick recording film 3, thus reducing the total thickness of the structure L0.

FIG. 2 shows that the light transmissivity of the first recording film 3 is higher by a few percent when the film 3 is in a recorded state in (b) than an unrecorded state in (a).

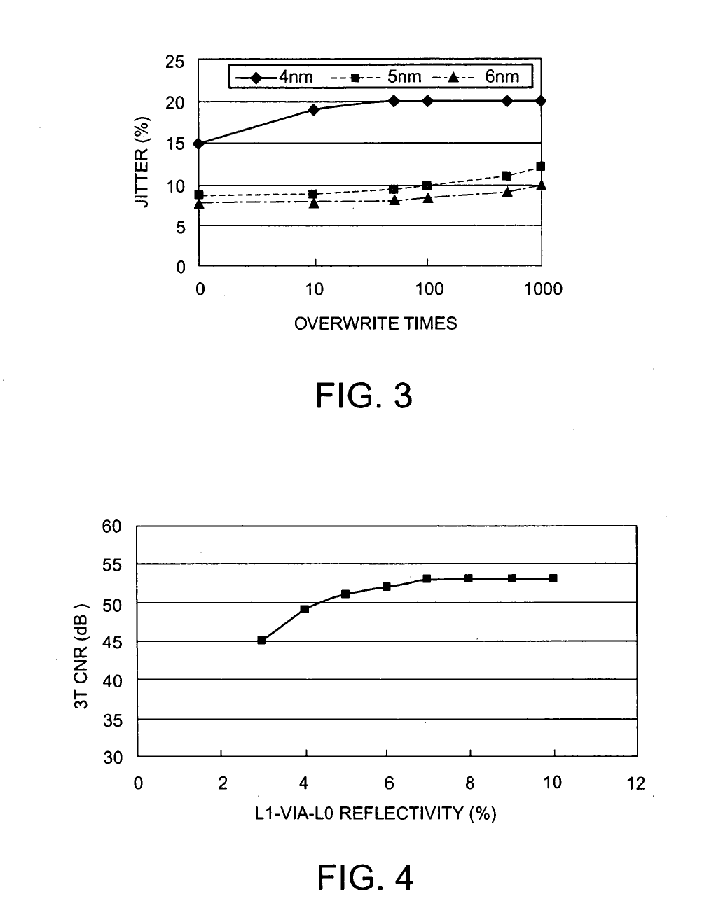

FIG. 3 shows DOW (Direct Over Write) jitter characteristics, or jitter versus the number of overwriting (Overwrite Times), with the thickness of the first recording film 3 as a parameter. Overwriting is 1-beam overwriting for erasing a recorded mark already formed and forming a new recorded mark with one-time laser scanning, in the disclosure. Also defined in the disclosure are: DOW 0; initial recording for forming a recorded mark on an unrecorded section of an initialized optical storage medium A; and DOW 1; 1st overwriting for forming another recorded mark on the initially recorded section.

FIG. 3 teaches the following for the optical storage medium A in this embodiment: a 4 nm-thick first recording film 3 cannot give jitter of 10% or less (excellent jitter characteristics); a 5 nm-thick recording film 3 gives jitter of over 10% at 101 times or more for the number of overwriting; and thus a thickness of the recording film 3 that offers excellent jitter characteristics is over 5 nm.

A thinner FGM-made first recording film 3 in this embodiment exhibits drastic decrease in crystallization speed due to boundary effects, thus not allowing erasure of recorded data. A 4 nm-thick recording film 3 (FIG. 3) exhibits a slower crystallization speed to make erasure harder. The minimum thickness of the recording film 3 that allows erasure is 5 nm, according to FIG. 3.

Accordingly, FIGS. 2 and 3 give the following discussion for the optical storage medium A in this embodiment:

An unrecorded 5 nm-thick first recording film 3 and a 4 nm-thick first reflective film 5 are the combination of the minimum film thickness that gives necessary characteristics to the optical storage medium A, according to (a) in FIG. 2 and FIG. 3, when the recording film 3 is in an unrecorded state. This combination gives a transmissivity Tc of 56%, as shown in the graph (a) in FIG. 2. This is, however, lower than a transmissivity Tr of 60% (for a recorded 5 nm-thick first recording film 3 and a 4 nm-thick first reflective film 5, the same thickness combination) in the graph (b) in FIG. 2, for the first laminated layer structure L0. A recorded film 3 is more suitable than an unrecorded film 3 because the former gives a higher transmissivity Tr (T0) than the latter to the structure L0.

A recorded 4 nm-thick first recording film 3 and a 4 nm-thick first reflective film 5 give a transmissivity Tr of 66% to the first laminated layer structure L0, according to (b) in FIG. 2. It is thus speculated, with the transmissivity Tr of 66%, that the second laminated layer structure L1 can exhibit an L1-via-L0 reflectivity R1 of 10%, as discussed above, if adjusted to exhibit an L1-peculiar reflectivity R11 of 25%. Nevertheless, 5 nm is the critical thickness for the first recording film 3 to achieve excellent crystallization speed and jitter characteristics, as shown in FIG. 3. It is thus almost impossible to gain 66% in transmissivity Tr for the first laminated layer structure L0 and 10% in L1-via-L0 reflectivity R1 for the second laminated layer structure L1, based on a higher transmissivity Tr.

It is therefore found, through the graphs (a) and (b) in FIG. 2 and FIG. 3, that 60% is the maximum transmissivity Tr for the first laminated layer structure L0.

FIG. 4 shows C/N (CNR) of a 3T signal reproduced from the optical storage medium A, in which the first and second recording films 3 and 8 have been recorded, with a 1-mW reproduction laser power in compliance with the DVD specifications, versus L1-via-L0 reflectivity R1. Recorded in the optical storage medium A is a signal of an 8/16 modulation random pattern.

FIG. 4 teaches an L1-via-L0 reflectivity R1 of 5% or higher gives a CNR of 50 dB or higher that is sufficient for practical use of the optical storage medium A. Below 50 dB in CNR could cause problems, such as, decrease in error rate. Accordingly, 5% is the minimum or critical L1-via-L0 reflectivity R1.

Decrease in crystallization speed due to boundary effects discussed above gives a minimum thickness to the first recording film 3 in terms of recording characteristics of the first laminated layer structure L0. It is thus difficult to offer or there is a limitation on a higher transmissivity T0 to the structure L0 with a thinner recording film 3.

Accordingly, a higher L1-via-L0 reflectivity R1 requires a higher L1-peculiar reflectivity R11 for the second laminated layer structure L1 in addition to a higher transmissivity T0 for the first laminated layer structure L0. A required high L1-peculiar reflectivity R11 is given with substantially no problems because the structure L1 does not need to allow a laser beam to pass therethrough, as discussed above.

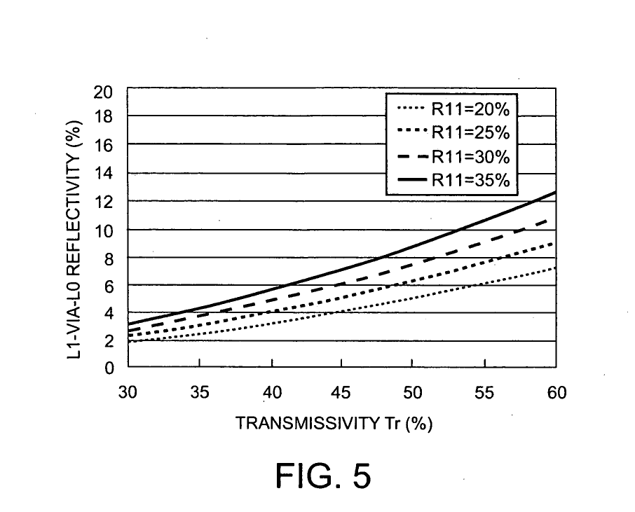

FIG. 5 shows a result of simulation of L1-via-L0 reflectivity R1 of the second laminated layer structure L1 versus transmissivity Tr of the first laminated layer structure L0, with L1-peculiar reflectivity R11 as a parameter. In this simulation, the second recording film 8 in the structure L1 was unrecorded whereas the first recording film 3 in the structure L0 was recorded once with a recording power and a write strategy for offering excellent jitter characteristics.

The L1-peculiar reflectivity R11 varies, for example, with variation in thickness of the fourth dielectric film 7 of the second laminated layer structure L1. A thicker film 7 for a higher L1-peculiar reflectivity R11, however, tends to lower modulation degree. An L1-peculiar reflectivity R11 of about 25% or higher causes difficulty in keeping a modulation degree of 50% or higher.

FIG. 5 teaches a higher L1-peculiar reflectivity R11 gives a required L1-via-L0 reflectivity R1, with a lower transmissivity Tr for the first laminated layer structure L0. In other words, the second laminated layer structure L1 with a higher L1-peculiar reflectivity R11 allows the structure L0 to have a lower transmissivity Tr, with an thick enough first recording film 3.

[Optical Recording/Reproducing Apparatus]

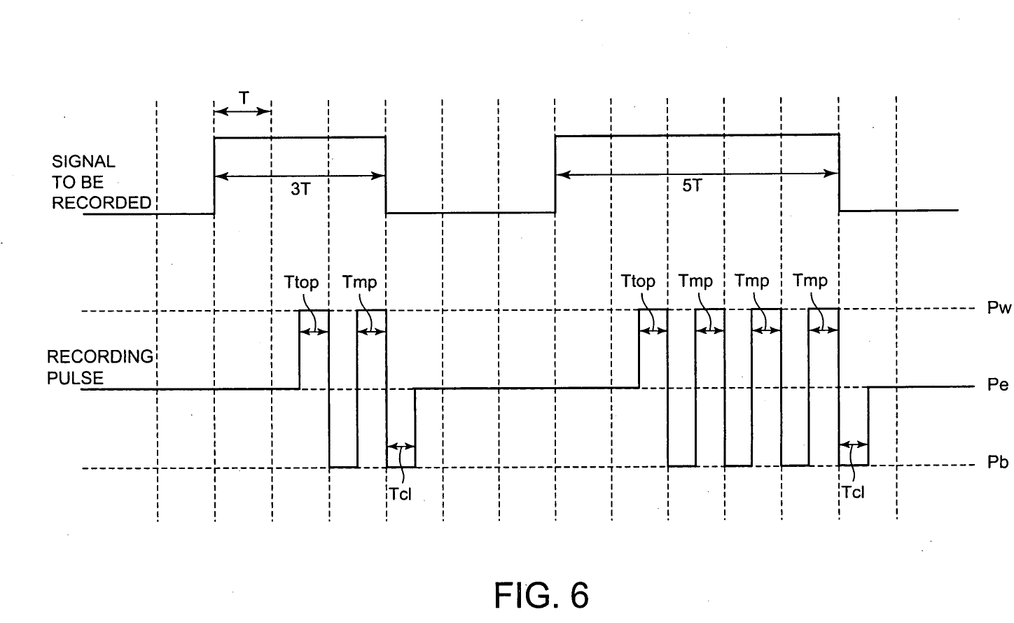

Disclosed next is an optical recording/reproducing apparatus capable of emitting a laser beam carrying recording pulse sequences, for example, illustrated in FIG. 6.

As illustrated in FIG. 6, each recording pulse sequence consists of a top pulse Ttop that rises from an erasing power Pe for initially applying a laser beam onto a recording film with a recording power Pw and multipulses Tmp, that follow the top pulse Ttop, for alternatively applying the recording power Pw and the bottom power Pb, with an erasing pulse Tcl that rises from the bottom power Pb in application of a laser beam with the erasing power Pe. The erasing pulse Tcl is located at the end of the sequence for each recorded mark. The top pulse Ttop and the multipulses Tmp constitute a heating (recording) pulse sequence for recording a recorded mark on a recording film. A recording pulse may be formed only with the top pulse Ttop with no multipulses Tmp. The term “multipulse Tmp” does not necessarily mean a plurality of pulses, or it may mean a single pulse, as shown in FIG. 6, in this disclosure.

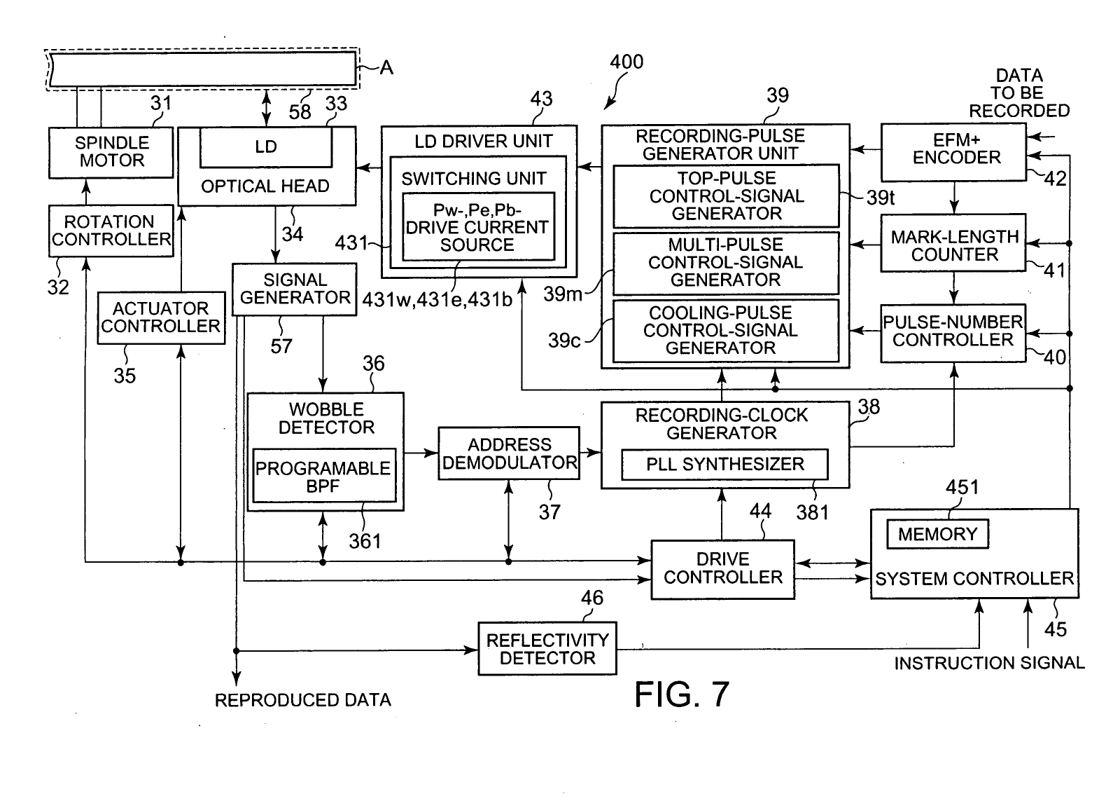

FIG. 7 is a block diagram of an embodiment of an optical recording/reproduction apparatus according to the present invention.

An optical storage medium A is rotated by a spindle motor 31. The spindle motor 31 is controlled by a rotation controller 32 so that its rotating speed reaches a recording linear velocity corresponding to a target recording speed. Provided as movable in the radius direction of the optical storage medium A is an optical head 34 equipped with a semiconductor laser (LD) 33 for use in recording, reproduction or erasing to the medium A, an objective lens (not shown) for focusing an irradiated laser beam of the LD 33, and a quadrant photo detector (not shown), for example.

A recommendable light source for recording in the optical recording apparatus of this embodiment is a high-intensity light source of a laser beam or strobe light, for example. Most recommendable is a semiconductor laser for compactness, low power consumption and easiness in modulation.

The quadrant photo detector of the optical head 34 receives a reflected light beam of a laser beam irradiated onto the optical storage medium A from the LD 33. Based on the light received by the photo detector, a signal generator 57 generates a push-pull signal and outputs it to a wobble detector 36. The signal generator 57 also outputs a focus error signal and a tracking error signal to a drive controller 44 based on the light received by the photo detector. It also outputs a reproduced (RF) signal that is a composite signal based on the output of the photo detector to the drive controller 44 and a reflectivity detector 46.

The drive controller 44 controls an actuator controller 35 based on the focus and tracking error signals supplied from the signal generator 57. The actuator controller 35 controls the optical head 34 in focusing and tracking to the optical storage medium A.

The drive controller 44 also controls the rotation controller 32, a wobble detector 36, an address demodulator 37, and a recording-clock generator 38. The controller 44 is under control by a system controller 45.

The wobble detector 36, equipped with a programmable band-pass filter (BPF) 361, outputs a detected wobble signal to the address demodulator 37. The demodulator 37 demodulates the detected wobble signal to output address information. The address information is input to the recording-clock generator 38, equipped with a PLL synthesizer 381, which generates recording-channel clocks and outputs them to a recording-pulse generator unit 39 and a pulse-number controller 40.

Disclosed next in detail is a reproduction operation from the optical storage medium A by the optical recording/reproducing apparatus shown in FIG. 7.

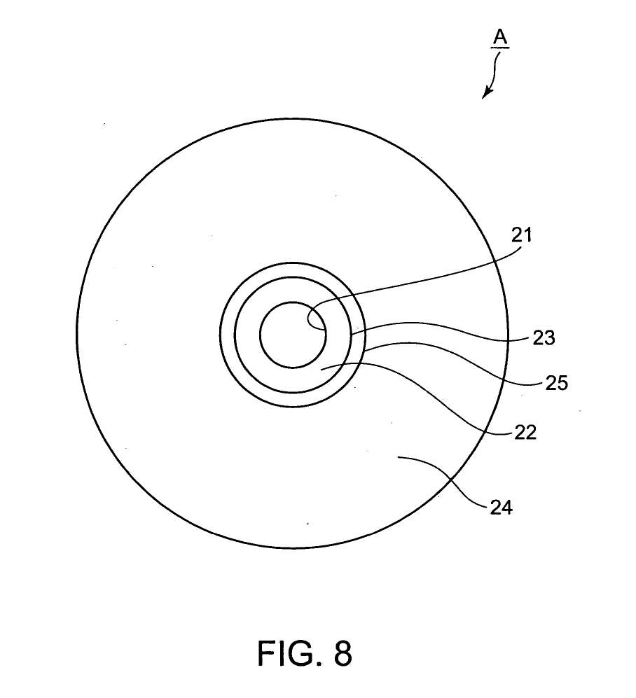

FIG. 8 is a plan view illustrating the optical storage medium A. The optical storage medium A has a center hole 21 and a clamp area 22 therearound. Provided concentrically around the clamp area 22 are a data area (read-in area) 23 and an optimum power control (OPC) zone 25 provided around which is a recording area 24 that stores actual data such as video data and audio data. The read-in area 23 may be in a condition like ROM (Read Only Memory) or RAM (Random Access Memory). Alternatively, a high-frequency wobble or bits carrying identification information (described later) can be formed in a laser guide groove for gaining a tracking signal, as read-only recorded data.

Recorded in the read-in area 23, as identification information, are recording requirements for the optical storage medium A so that it can store data with excellent characteristics. The identification information includes several recording requirements: recording pulse sequence information indicating switching of recording pulse sequences used in formation of recorded marks based on data to be recorded; laser strengths of a laser beam (a recording power Pw, an erasing power Pe, etc.); recording parameter (requirement) indicating a laser-power applying duration (pulse width), and so on. The identification information may further include a type of optical storage medium A, any information on a manufacturer of the medium A, the number of laminated layer structures (L0, L1, etc.) of the medium A, a transmissivity Tr of each layer structure.

When an optical storage medium A having data recorded in the recording area 24 is set in a disc loading mechanism 58, the spindle motor 31 is controlled by the rotation controller 32 so that the medium A is rotating at a recording linear velocity corresponding to a target recording speed. A laser beam having a relatively small power for reproduction is emitted from the LD 33 of the optical head 34 to the read-in area 23 of the medium A. A reflected beam from the read-in area 23 is received by the quadrant photo detector of the optical head 34 and supplied to the signal generator 57. The optical head 34 and the signal generator 57 operate together as a reproducer for reproducing data from the medium A.

The signal generator 57 outputs a reproduced signal based on the reflected beam to the reflectivity detector 46. The detector 46 detects the polarity of a gradient of change in reflectivity of the reproduced signal to determine whether the beam is reflected from the first laminated layer structure L0 or the second laminated layer structure L1. The result of determination is sent to the system controller 45 that controls the actuator controller 35 via the drive controller 44 to move up or down the optical storage medium A and/or the optical head 34 so that the reproducing laser beam is focused onto a target recording film of the layer structure L0 or L1. The controller 35 operates as a focus/tracking controller to control the optical head 34 in focusing onto each recording film and tracking to tracks formed on the recording film of the medium A.

Under focusing and tracking control by the actuator controller 35, the optical head 34 receives a beam from the recording area 24 of the optical storage medium A and sends it to the signal generator 57. The generator 57 generates a reproduced signal which is demodulated by a demodulator (not shown) and output as reproduced data. With the reproduction and demodulation, the generator 57 outputs a radial push-pull signal to the wobble detector 36. The detector 36 extracts a wobble signal and an LPP signal from the push-pull signal. The address demodulator 37 receives and demodulates the LPP signal to gain address information which is supplied to the drive controller 44.

Disclosed next is a recording operation to the optical storage medium A by the optical recording/reproducing apparatus shown in FIG. 7.

When an optical storage medium A having an unrecorded section in the recording area 24 is set in the disc loading mechanism 58, a laser beam having a relatively small power for reproduction is emitted from the LD 33 of the optical head 34 to the read-in area 23 of the medium A. A reflected beam from the read-in area 23 is received by the quadrant photo detector of the optical head 34 and supplied to the signal generator 57.

The signal generator 57 generates a reproduced signal based on the reflected beam and demodulates the reproduced signal to gain the identification information (recording pulse sequence information, recording parameter data, etc.). The identification information is supplied to the system controller 45.

The system controller 45 stores the identification information in the memory 451 for controlling the drive controller 44 based on the stored information. The drive controller 44 controls the actuator controller 35, the wobble detector 36, and the address demodulator 37, under control by the system controller 45.

In recording, the system controller 45 operates as a controller to generate a command signal indicating that data must be recorded in the first laminated layer structure L0 or the second laminated layer structure L1.

The reflectivity detector 46 detects the polarity of a gradient of change in reflectivity of a laminated layer structure based on a beam reflected therefrom to determine whether the layer structure is the first or the second laminated layer structure L0 or L1. The actuator controller 35 controls the optical head 34 in focusing and tracking to the structure L0 or L1, based on the command signal, discussed above.

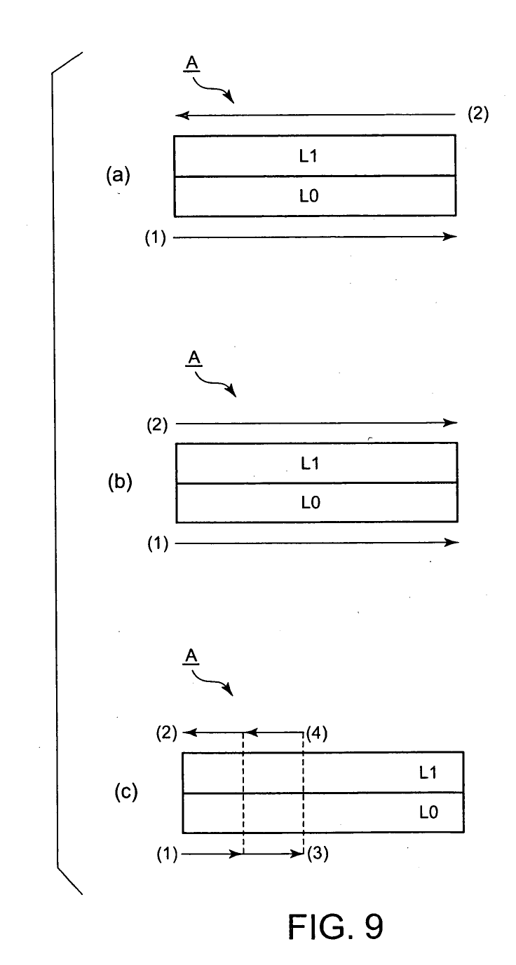

The system controller 45 generates the command signal based on three recording file systems stored in the memory 451. The three recording file systems are illustrated in FIG. 9.

A recording file system shown in (a) of FIG. 9 is an opposite type in which recoding is performed, at first, to the first recording film 3 of the first laminated layer structure L0, entirely from the inner to the outer edge of the film 3, as indicated by an arrow (1), followed by recoding to the second recording film 8 of the second laminated layer structure L1, entirely from the outer to the inner edge of the film 8, as indicated by an arrow (2).

A recording file system shown in (b) of FIG. 9 is a parallel type in which recoding is performed, at first, to the first recording film 3 of the first laminated layer structure L0, entirely from the inner to the outer edge of the film 3, as indicated by an arrow (1), followed by recoding to the second recording film 8 of the second laminated layer structure L1, entirely from the inner to the outer edge of the film 8, as indicated by an arrow (2).

A recording file system shown in (c) of FIG. 9 is an opposite type in which recoding is performed, at first, to the first recording film 3 of the first laminated layer structure L0, from the inner edge to a given position on the film 3, for a given area on the film 3 with a radius from the center of the structure L0, as indicated by an arrow (1), followed by recoding to the second recording film 8 of the second laminated layer structure L1, from a given position on the film 8, almost equal to the position on the film 3, to the outer edge, for the same given area on the film 8, as indicated by an arrow (2). The recording is repeated in the same manner for each unrecorded section next to the recorded section on the structure L0, as indicated by an arrow (3), and also the structure L1, as indicated by an arrow (4).

Overwriting may be performed to recorded sections in either the first or the second laminated layer structure L0 or L1 in any of the above three recording file systems.

A laser beam for recording is emitted from the optical head 34 to the optical storage medium A. A wobble signal detected by the wobble detector 36 is supplied to the recording-clock generator 38 through the drive controller 44. Address information gained by the address demodulator 37 is supplied to the system controller 45 through the drive controller 44. The Address information is further supplied to the recording-clock generator 38, equipped with the PLL synthesizer 381, which generates recording-channel clocks and outputs them to the recording-pulse generator unit 39 and the pulse-number controller 40.

The system controller 45 controls an EFM+encoder 42, a mark-length counter 41, the pulse-number controller 40, a recording-pulse generator unit 39, and an LD driver unit 43.

The EFM+encoder 42 modulates input data to be recorded into modulated data with 8/16 modulation and outputs it to the recording-pulse generator unit 39 and the mark-length counter 41. The mark-length counter 41 works as a mark-length generator that counts intervals of inversion of the modulated data to generate mark-length data, the counted value being output to the recording-pulse generator unit 39 and the pulse-number controller 40. The pulse-number controller 40 controls the recording-pulse generator unit 39 to generate specific recording pulses based on the supplied counted value and recording-channel clocks.

The recording-pulse generator unit 39 is equipped with a top-pulse control-signal generator 39t, a multipulse control-signal generator 39m, and a cooling-pulse control-signal generator 39c. The generators 39t, 39m and 39c generate a top-pulse control signal, a multipulse control signal, and a cooling-pulse control signal, respectively. Each control signal is supplied to the LD driver unit 43. A switching unit 431 switches a drive current source 431w for recording power Pw, a drive current source 431e for erasing power Pe, and a drive current source 431b for bottom power Pb based on the supplied control signals, thus generating a recording pulse sequence.

The Pw-drive current source 431w, the Pe-drive current source 431e, and the Pb-drive current source 431b supply currents to the optical head 34 based on a recording power Pw, an erasing power Pe and a bottom power Pb prestored in the memory 451 of the system controller 45. These three values are optimum values for offering the optical storage medium A excellent recording characteristics. Identification information that indicates these three values may be prestored or updated in the memory 451. The memory 451 is either a ROM (Read Only Memory) or a recordable RAM (Random Access Memory), for example.

The optical recording apparatus in this embodiment can set any recording linear velocity selected among a plurality of recording linear velocities for higher linear velocity (x speed) for the optical storage medium A. On receiving an instruction signal for selecting a recording linear velocity (x speed mode), the system controller 45 controls the Pw-drive current source 431w, the Pe-drive current source 431e, and the Pb-drive current source 431b, as disclosed above, based on identification information on an instructed recording linear velocity and prestored in the memory 451. Identification information on a plurality of recording linear velocities are prestored in the memory 451, as disclosed above.

A generated recording pulse sequence is input to the optical head 34. The optical head 34 controls the LD 33 to output LD-emission waveforms with a desired recording pulse sequence and power, thus recording data in the optical storage medium A.

The recording-pulse generator unit 39, the LD driver unit 43, and the optical head 34 work together as a recording unit 400 that generates a recording pulse sequence based on the mark-length data generated by the mark-length counter 41, and irradiates a recording beam onto a recording film 3 of the optical storage medium A through the LD 33 in accordance with the recording pulse sequence, thus forming recorded marks indicating data to be recorded.

[Structure of Optical Storage Medium]

Several samples of the dual-layer phase change optical storage medium A shown in FIG. 1 were produced with variation in thickness for the first recording film 3 and the first reflecting film 5 of the first laminated layer structure L0 for evaluation of several characteristics, such as transmissivity and reflectivity.

### Embodiment Sample 1

Several films which will be disclosed later, were formed on a first substrate 1 made of a polycarbonate resin with 120 mm in diameter and 0.6 mm in thickness. Grooves were formed on the substrate 1 at 0.74 μm in track pitch, with 25 nm in groove depth and about 40:60 in width ratio of groove to land. The grooves stuck out when viewed from an incident direction of a laser beam in recording.

After a vacuum chamber was exhausted up to 3×10⁻⁴ Pa, a 70 nm-thick first dielectric film 2 was formed on the first substrate 1 by high-frequency magnetron sputtering with a target of ZnS added with 20-mol % SiO₂ at 2×10⁻¹ Pa in Ar-gas atmosphere.

Formed on the first dielectric film 2, in order, were a 5 nm-thick first recording film 3 with a target of an alloy of 4 elements Ge—In—Sb—Te, a 9 nm-thick second dielectric film 4 of the same material as the first dielectric film 2, and a 4 nm-thick semi-transparent first reflective film 5 with a target of Ag alloy.

The first substrate 1 was taken out from the vacuum chamber. The semi-transparent first reflective film 5 was spin-coated with an acrylic ultraviolet-cured resin (SK5110 made by Sony Chemicals. Co.). The resin was cured with radiation of ultraviolet rays so that a 3 μm-thick first protective film 6 was formed on the reflective film 5, thus a first laminated layer structure L0, such as shown in FIG. 1, was produced.

Formed in order on a second substrate 11, produced in the same manner as the first substrate 1, by sputtering with the same requirements as the first laminated layer structure L0, were a 120 nm-thick second reflective film 10 with a target of Ag alloy, a 16 nm-thick third dielectric film 9 of the same material as the first dielectric film 2, a 16 nm-thick second recording film 8 with a target of an alloy of 4 elements Ge—In—Sb—Te, and an 80 nm-thick fourth dielectric film 7. This laminated structure exhibited 25% in L1-peculiar reflectivity R11.

The second substrate 11 was taken out from the vacuum chamber. The fourth dielectric film 7 was spin-coated with an acrylic ultraviolet-cured resin (SK5110 made by Sony Chemicals. Co.). The resin was cured with radiation of ultraviolet rays so that a 3 μm-thick second protective film 12 was formed on the dielectric film 7, thus a second laminated layer structure L1, such as shown in FIG. 1, was produced.

Both of the first and second laminated layer structures L0 and L1 were initialized by an initialization apparatus (POP120 made by Hitachi Computer Peripherals, Co.). The structures L0 and L1 were bonded to each other with a double-sided adhesive sheet 13 (bonding layer 13) so that the first and second protective films 6 and 12 faced with each other, thus a dual-layer phase-change optical storage medium A, such as shown in FIG. 1, was produced.

Measured for the “lone” first laminated layer structure L0, before bonded to the second laminated layer structure L1 were a transmissivity Tc and a reflectivity Rc in an unrecorded state (after initialized), and also a transmissivity Tr and a reflectivity Rr in a recorded state. The “lone” first laminated layer structure L0 is referred to as a layer structure that consists of the first substrate 1 and the structure L0 formed thereon. A reflectivity Rc of the structure L0 with an unrecorded first recording film 3 and a reflectivity Rr of the structure L0 with a recorded first recording film 3 are both referred to as a reflectivity R0 of the structure L0, in the following discussion.

A reflectivity R0 and a trasmissivity T0 of the first laminated layer structure L0 were measured with an analysis instrument ETA-RT made by Steag ETA—Optick GmBH., using a parallel laser beam having the second area (defined above) with a 650 nm-band wavelength, through the light-incident surface 1A of the first substrate 1.

Recording was performed only once to the first recording film 3 by means of a write strategy with an 8/16 modulation random pattern based on the recording pulse sequence, shown in FIG. 6, in compliance with DVD-RW Version-1.1 specification. The number of the top pulse Ttop and the multipulses Tmp for applying the recording power Pw was (n−1) for a mark length of nT. The other recording requirements were: 7.7 m/s in recording linear velocity (corresponding to ×2 speed in DVD—Video dual-layer specification); 19.2 ns in unit clock (DVD×2 speed); and 0.293 μm/bit in bit length. Recording was performed in the same density as DVD-Video for the storage capacity corresponding to dual-layer 8.5 gigabytes.

An absorption rate A0 was gained as A0 (%)=100 (%)−transmissivity T0 (%)−reflectivity R0 (%) for the first laminated layer structure L0. The following two types of absorption rate are both referred to as an absorption rate A0 of the structure L0 in this disclosure: an absorption rate Ac gained based on a transmissivity Tc and a reflectivity Rc, with an unrecorded first recording film 3; and an absorption rate Ar gained based on a transmissivity Tr and a reflectivity Rr, with a recorded first recording film 3.

Measured next were a reflectivity Rc1 and also a reflectivity Rr1 of the second laminated layer structure L1 after bonded to the first laminated layer structure L0. The reflectivity Rc1 was measured when the first recording film 3 was unrecorded whereas the reflectivity Rr1 the film 3 recorded. Both of the reflectivity Rc1 and Rr1 are referred to as a reflectivity R1 of the structure L1 in this disclosure.

A reflectivity R1 was measured for the second laminated layer structure L1 according to the following procedure:

Recoding was conducted to the second recording film 8 of the second laminated layer structure L1 ten times under the same recording requirements as the first recording film 3 of the first laminated layer structure L0. A reflectivity R1 was then measured by an evaluation instrument while a laser beam was being focused onto the first area (defined above) on the recorded film 8. The 10-time recoding was conducted in way that data was recorded on the second recording film 8 of the structure L1 through the recorded section of the first recording film 3 of the structure L0.

Measured next was modulation degree based on a procedure (I14/I14H) in compliance with the DVD-RW specifications after recoding was conducted to the second recording film 8 of the second laminated layer structure L1 ten times with an 8/16 modulation random pattern.

Evaluated further were recording and jitter characteristics with a laser beam focused onto the first recording film 3 of the first laminated layer structure L0. Recording was conducted ten times (DOW9) to a target track and adjacent tracks, followed by measurements of clock to data jitters by slicing at the amplitude center of a reproduced signal. The laser power Pr of a reproducing beam was constant at 1.4 mW.

Jitter was measured for overwrite characteristics after 1000-th recording (DOW999).

Defined further in the disclosure are: “excellent” in jitter of 9% or less for 10-th recording (DOW9); and also “excellent” in jitter of 12% or less for 1000-th recording (DOW999), 12% being the maximum level at and beyond which an error rate starts to increase for the 1000-th recording.

The above measurement specifications and several definitions in evaluation of the recording characteristics were also used for embodiment samples 2 to 4 and comparative samples 1 to 3, which will be discussed later.

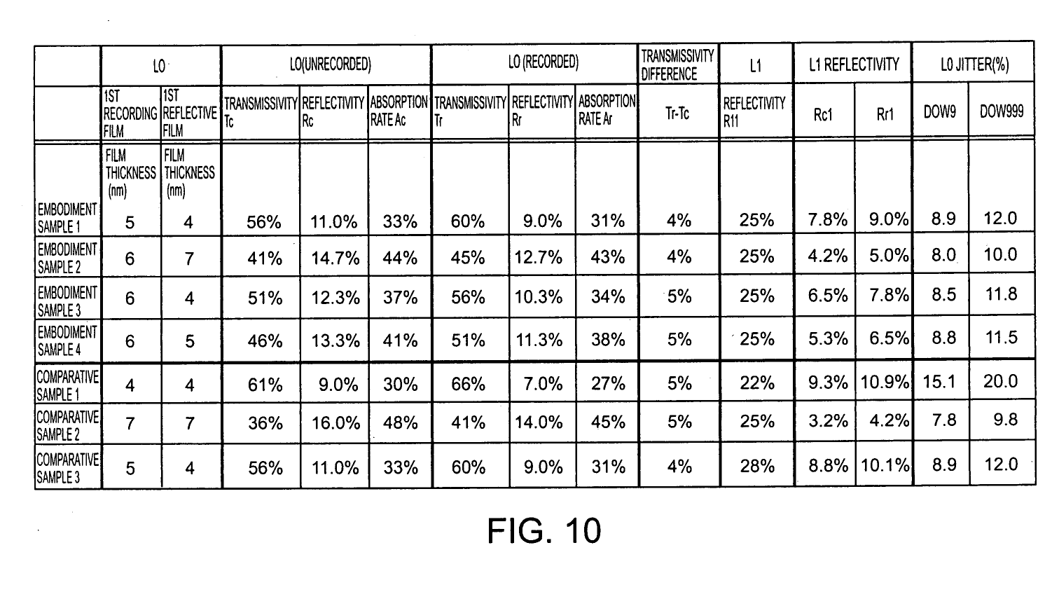

Measured results were as shown in FIG. 10 for the embodiment sample 1: 56% and 11% in transmissivity Tc and reflectivity Rc, respectively, for the first laminated layer structure L0 with an unrecorded first recording film 3; and 60% and 9% in transmissivity Tr and reflectivity Rr, respectively, for the structure L0 having the film 3 recorded.

Other measured results were: 8.9% in DOW9 jitter, excellent, although close to 9%; and 12.0% in DOW999 jitter, excellent, in spite of very high transmissivity Tr of 60%, in the initial and overwrite characteristics.

Another measured result was 9% in reflectivity Rr1 of the second laminated layer structure L1 through the first laminated layer structure L0 having the first recording film 3 recorded. The reflectivity Rr1 of 9% is very excellent, or much higher than 5%, the minimum level of the reflectivity R1 of the structure L1, discussed above.

Although, not shown in FIG. 10, a modulation degree was 53%, exceeding 50%, for the second laminated layer structure L1.

### Embodiment Sample 2

The optical storage medium A in the embodiment sample 2 was identical to that of the embodiment sample 1 except for a 6 nm-thick first recording film 3 with a target of an alloy of 4 elements Ge—In—Sb—Te and a 7 nm-thick semi-transparent first reflective film 5 with a target of Ag alloy.

A measured result in FIG. 10 was 5.0%, the minimum level, in reflectivity Rr1 of the second laminated layer structure L1 through the first laminated layer structure L0 having the first recording film 3 recorded.

In contrast, DOW9 jitter and DOW999 jitter were 8.0% and 10.0%, respectively, for the first laminated layer structure L0, thus very excellent recording characteristics being gained.

### Embodiment Sample 3

The optical storage medium A in the embodiment sample 3 was identical to that of the embodiment sample 1 except for a 6 nm-thick first recording film 3 with a target of an alloy of 4 elements Ge—In—Sb—Te and a 4 nm-thick semi-transparent first reflective film 5 with a target of Ag alloy.

Measured results in FIG. 10 were: 7.8% in reflectivity Rr1 of the second laminated layer structure L1; and 8.5% and 11.8% in DOW9 jitter and DOW999 jitter, respectively, for the first laminated layer structure L0, thus excellent recording characteristics being gained.

### Embodiment Sample 4

The optical storage medium A in the embodiment sample 4 was identical to that of the embodiment sample 1 except for a 6 nm-thick first recording film 3 with a target of an alloy of 4 elements Ge—In—Sb—Te and a 5 nm-thick semi-transparent first reflective film 5 with a target of Ag alloy.

Measured results in FIG. 10 were: 6.5% in reflectivity Rr1 of the second laminated layer structure L1; and 8.8% and 11.5% in DOW9 jitter and DOW999 jitter, respectively, for the first laminated layer structure L0, thus excellent recording characteristics being gained.

(Comparative Sample 1)

The optical storage medium A in the comparative sample 1 was identical to that of the embodiment sample 1 except for a 4 nm-thick first recording film 3 with a target of an alloy of 4 elements Ge—In—Sb—Te and a 4 nm-thick semi-transparent first reflective film 5 with a target of Ag alloy.

Measured results in FIG. 10 were: 10.9%, excellent, in reflectivity Rr1 of the second laminated layer structure L1, with a transmissivity T0 (Tr, Tc) of over 60% for the first laminated layer structure L0; whereas 15.1% and 20.0% in DOW9 jitter and DOW999 jitter, respectively, for the structure L0, very poor recording characteristics being gained.

(Comparative Sample 2)

The optical storage medium A in the comparative sample 2 was identical to that of the embodiment sample 1 except for a 7 nm-thick first recording film 3 with a target of an alloy of 4 elements Ge—In—Sb—Te and a 7 nm-thick semi-transparent first reflective film 5 with a target of Ag alloy.

Measured results in FIG. 10 were: 4.2%, very poor, in reflectivity Rr1 of the second laminated layer structure L1, giving CNR below 50 dB for a 3T signal as discussed with reference to FIG. 4, thus not for practical use, in spite of very excellent in recording characteristics with 7.8% and 9.8% in DOW9 jitter and DOW999 jitter, respectively, for the first laminated layer structure L0.

(Comparative Sample 3)

The optical storage medium A in the comparative sample 3 was produced with the first laminated layer structure L0 identical to that of the embodiment sample 1 and the second laminated layer structure L1 identical to that of the embodiment sample 1 except for a 16 nm-thick third dielectric film 9 of the same material as the first protective film 2, a 16 nm-thick second recording film 8 with a target of an alloy of 4 elements Ge—In—Sb—Te and a 110 nm-thick fourth dielectric film 7, exhibiting 28% in L1-peculiar reflectivity R11.

Measured results in FIG. 10 were: 10.1%, in reflectivity Rr1 of the second laminated layer structure L1, over 10% due to very high L1-peculiar reflectivity R11 of 28%, with excellent characteristics for the first laminated layer structure L0; whereas poor characteristics for the structure L1, in particular, 46%, very poor in modulation degree. The laminated layer structure for higher L1-peculiar reflectivity R11 caused very poor in modulation degree below the minimum level of 50%. Thus, the comparative sample 3 cannot be put into practical use.

Discussed next is an appropriate range for the reflectivity Rr1 of the second laminated layer structure L1 through the first laminated layer structure L0 having an unrecorded first recording film 3, based on the measured results of the embodiment samples 1 to 4 and comparative samples 1 to 3.

The measured results show the following, concerning the reflectivity Rr1 of the second laminated layer structure L1:

The embodiment samples 1 to 4 with a reflectivity Rr1 in the range from 5% to 10% exhibited excellent recording characteristics for the first laminated layer structure L0.

The comparative sample 1 with a higher transmissivity Tr for the first laminated layer structure L0 having a thinner first recording film 3 and a thinner first reflective film 5, for a reflectivity Rr1 of 10% or higher, suffered decrease in crystallization speed due to boundary effects on the film 3, thus exhibited drastic degradation in recording characteristics.

The comparative sample 2 with a reflectivity Rr1 below 5% exhibited a lowered CNR, thus not for practical use, as shown in FIG. 2.

The comparative sample 3 with a higher L1-peculiar reflectivity R11 for a higher reflectivity Rr1 suffered poor recording characteristics for the second laminated layer structure L1, with drastic decrease in modulation degree.

The evaluation teaches that a higher L1-peculiar reflectivity R11 causes difficulty in achieving excellent recording characteristics with a reflectivity Rr1 of 10% or higher for the second laminated layer structure L1.

It is thus concluded that an appropriate range for the reflectivity Rr1 of the second laminated layer structure L1 that gives excellent recording characteristics is in the range from 5% to 10% for the optical storage medium A having the first laminated layer structure L0 (located in the beam-incident side) having the first recording film 3 recorded, to a laser beam with a 650 nm-band wavelength.

Discussed next is an appropriate range for the transmissivity T0 (Tc, Tr), reflectivity R0 (Rc, Rr) and absorption rate A0 (Ac, Ar) for the first laminated layer structure L0 having the first recording film 3 unrecorded or recorded, based on the measured results in the embodiment samples 1 to 4 and the comparative samples 1 to 3.

The following is shown in FIG. 10 concerning the factors listed above for the first laminated layer structure L0 having the first recording film 3 unrecorded or recorded:

(1) a transmissivity Tc with an unrecorded first recording film 3 is equal to or lower than a transmissivity Tr with a recorded film 3 (Tc≦Tr);

(2) a reflectivity Rr with a recorded first recording film 3 is equal to or lower than a reflectivity Rc with an unrecorded film 3 (Rr≦Rc); and

(3) an absorption rate Ar with a recorded first recording film 3 is lower than an absorption rate Ac with an unrecorded film 3 (Ar<Ac).

A transmissivity Tr with a recorded first recording film 3 equal to or higher than a transmissivity Tc with an initialized and unrecorded film 3 gives compatibility in recording to dual-layer phase-change optical storage media.

Therefore, in order to achieve excellent recording characteristics, it is preferable for the optical storage medium A in this invention to meet the above three relations (1), (2) and (3) on the transmissivity T0, reflectivity R0 and absorption rate A0 for the first laminated layer structure L0, and moreover, to meet the ranges Tc≦Tr≦60% and 9%≦Rr≦Rc≦15%

The above specific ranges for Tc and Tr, and Rr and Rc were given with a parallel laser beam having the second area (defined above) and a 650 nm-band wavelength.

The parallel beam was employed in the present invention under speculation that several characteristics of the first laminated layer structure L0, particularly, transmissivity, might depend on whether the first recording film 3 was unrecorded or recorded.

It was not employed to evaluate the difference in transmissivity between an unrecorded section (a crystalline state) of a recording film and a marked section (an amorphous state) formed in the recording film in recording, such as, discussed in the document 1.

Disclosed in the document 1 is the layer structure with A1<A2 and R2<R1 or A1>A2 and R2>R1 where A1 and A2 are the absorption rate in a crystalline state (an unrecorded state) and an amorphous state (a recorded state), respectively, and R1 and R2 the reflectivity in the crystalline and amorphous states, respectively.

These are the requirements for a smaller difference in transmissivity between an unrecorded section (a crystalline state) and a marked section (an amorphous state) for recording in a recording film.

These requirements are completely different from the three relations (1), (2) and (3), and also the specific ranges Tc≦Tr≦60% and 9%≦Rr≦Rc≦15%, discussed above in the present invention.

FIG. 10 further teaches thickness ranges 5 nm to 6 nm and 4 nm to 6 nm are appropriate for the first recording film 3 and the first reflective film 5, respectively, in achieving excellent characteristics.

In FIG. 10, the embodiment sample 2 exhibited a high reflectivity Rr1 of 5% for the second laminated layer structure L1 through the first laminated layer structure L0 having a recorded first recording film 3 whereas a low reflectivity Rc1 of 4.2% for the structure L1 through the structure L0 having an unrecorded film 3, with a low CNR.

It is, thus, preferable for the optical storage medium A, when produced like the embodiment sample 2, to employ a procedure of recording to the second laminated layer structure L1 after recording to the first laminated layer structure L0, not to the structure L1 before the structure L0.

Evaluated next were two types of recording procedure to record the second laminated layer structure L1 before and after the first laminated layer structure L1, for several samples of the optical storage medium A produced in the same way as the embodiment sample 1 or 2.

A first recording procedure (L0-recorded L1 recording) is recording to the second laminated layer structure L1 (second recording film 8) after recording to the first laminated layer structure L0 (first recording film 3). In contrast, a second recording procedure (L0-unrecorded L1 recording) is recording to the structure L1 before the structure L0.

In the first recording procedure, data was recorded in the first recording film 3 of the first laminated layer structure L0 with a laser beam focused onto a specific area section of the film 3, and then, data was recorded in the second recording film 8 of the second laminated layer structure L1 through the recorded specific area section of the film 3.

The reflectivity R1 of the second laminated layer structure L1 was evaluated in the same way as the embodiment sample 1 or 2. The jitter characteristics of the structure L1 was evaluated with a laser beam focused onto the second recording film 8 of the structure L1, according to the same requirements as for the first laminated layer structure L0.

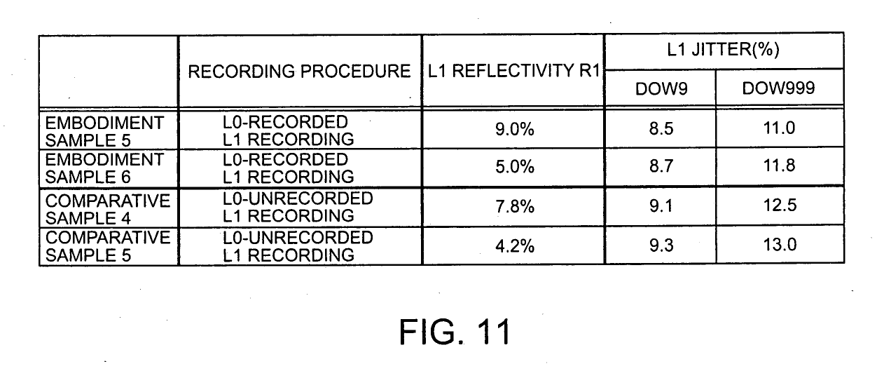

The results are shown in FIG. 11 in which the first recording procedure and the second recording procedure are referred to as L0-recorded L1 recording and L0-unrecorded L1 recording, respectively.

The four samples of the optical storage medium A listed in FIG. 11 are as follows: an embodiment sample 5 identical to the embodiment sample 1, recorded according to the first recording procedure; an embodiment sample 6 identical to the embodiment sample 2, recorded according to the first procedure; a comparative sample 4 identical to the embodiment sample 1, recorded according to the second recording procedure; and a comparative sample 5 identical to the embodiment sample 2, recorded according to the second procedure.

FIG. 11 shows the following results: the embodiment samples 5 and 6, excellent, in reflectivity R1 (Rr1) and jitter characteristics for the second laminated layer structure L1; the comparative sample 4, poor, in jitter characteristics; and the comparative sample 5, below 5% in reflectivity R1 (Rc1) for the structure L1, with over 50 dB in CNR, out of the specifications, with poor jitter characteristics, particularly, in DOW999, for the structure L1, in spite of fairly successful recording and reproduction.

The results in FIG. 11 teach that the first recording procedure gives a wider margin to the optical storage medium A in terms of film thickness and also in achieving excellent characteristics, in the present invention.

In addition to the method described above, the optical storage medium A according to the present invention can be produced in different ways. One of the options is as follows: at least a first dielectric film 2, a first recording film 3, a second dielectric film 4, and a first semi-transparent reflective film 5 are laminated in order on a first substrate 1; a resultant laminated layer structure L0 is coated with a UV curable resin; the resin is exposed to UV rays to be cured, through a transparent stamper for use in recorded-groove transfer, attached on the structure L0; and, after the stamper is peeled off, a fourth dielectric film 7, a second protective film 8, a third dielectric film 9, and a second reflective film 10 are laminated in order on the structure L0. Other films, such as, a transparent dielectric film may further be formed on the semi-transparent reflective film 5.

As disclosed in detail, the present invention achieves excellent recording and overwrite characteristics in each of a plurality of recording films in multilayer phase-change optical storage media. The same is true even when each recording film is an FGM film.

What is claimed is:

1. An optical storage medium comprising:
a substrate;
a first laminated layer structure formed on the substrate and having at least a first reflective film and a first recording film; and
a second laminated layer structure formed over the first laminated layer structure and having at least a second reflective film and a second recording, the second laminated layer structure exhibiting a reflectivity of 5% or higher but 10% or lower when a beam having a wavelength in a 650-nm band is focused onto the second recording film, as having a beam spot having a specific area, through the substrate and the first laminated layer structure, and when the first recording film has data recorded therein.

2. The optical storage medium according to claim 1, wherein the first laminated layer structure satisfies requirements Tc≦Tr≦60% and 9%≦Rr≦Rc≦15% wherein Tc and Rc are a transmissivity and a reflectivity, respectively, of the first laminated layer structure when the first recording film has no data recorded therein after initialized, and Tr and Rr are a transmissivity and a reflectivity, respectively, of the first laminated layer structure when the first recording film has data recorded therein, the transmissivity Tc and the reflectivity Rc, and the transmissivity Tr and the reflectivity Rr being exhibited by the first laminated layer structure when the beam is emitted thereto through the substrate as a parallel beam having a sectional area in a direction orthogonal to another direction in which the beam travels, the sectional area being larger than the specific area.

3. A method of recording data in an optical storage medium comprising the steps of:
recording data in the optical storage medium having a substrate, a first laminated layer structure formed on the substrate and having at least a first reflective film and a first recording filn, and a second laminated layer structure formed over the first laminated layer structure and having at least a second reflective film and a second recording film, the data being recorded in at least one of a plurality of specific sections of the first recording film of the first laminated layer structure, with a beam having a wavelength in a 650-nm band and a beam spot having a specific area, the first laminated layer structure satisfying requirements Tc≦Tr≦60% and 9%≦Rr≦Rc≦15% wherein Tc and Rc are a transmissivity and a reflectivity, respectively, of the first laminated layer structure when the first recording film has no data recorded therein after initialized, and Tr and Rr are a transmissivity and a reflectivity, respectively, of the first laminated layer structure when the first recording film has the data recorded therein, the transmissivity Tc and the reflectivity Rc, and the transmissivity Tr and the reflectivity Rr being exhibited by the first laminated layer structure when the beam is emitted thereto through the substrate as a parallel beam having a sectional area in a direction orthogonal to another direction in which the beam travels, the sectional area being larger than the specific area; and
recording data in the second recording film of the second laminated layer structure through the substrate and the data-recorded specific section of the first recording film of the first laminated layer structure, the second laminated layer structure exhibiting a reflectivity of 5% or higher but 10% or lower when the beam is focused onto the second recording film, as having the beam spot having the specific area, through the substrate and the first laminated layer structure, and when the first recording film has the data recorded therein.

4. The method in claim 3 further comprising the steps of:
recording data in the specific sections of the first recording film of the first laminated layer structure, in a direction from a center of the first recording film to an outer edge thereof; and
recording data in the second recording film of the second laminated layer structure through the substrate and each data-recorded specific section of the first recording film of the first laminated layer structure, in a direction from a center of the second recording film to an outer edge thereof or vice versa.

5. The method in claim 4, wherein the data recording in the second recording film of the second laminated layer structure is performed after the data recording in all of the specific sections of the first recording film of the first laminated layer structure.

6. The method in claim 4, wherein the data recording in the second recording film of the second laminated layer structure is performed after the data recording in each specific section of the first recording film of the first laminated layer structure.
